(19) United States
(12) Patent Application Publication
(10) Pub. No.: US 2015/0370680 A1
(43) Pub. Date: Dec. 24, 2015

(54) METHOD FOR TRANSMITTING HUMAN INPUT EVENT AND ELECTRICAL DEVICE

(71) Applicant: Halo-Digi Technology Co., Ltd., Taipei City (TW)

(72) Inventor: Chia-Shen CHIANG, Taipei City (TW)

(21) Appl. No.: 14/309,899

(22) Filed: Jun. 20, 2014

(51) Int. Cl. G06F 11/30; G06F 11/32

(52) U.S. Cl. CPC G06F 11/3051; G06F 11/321; G06F 11/302

(57) ABSTRACT

A method for transmitting a human input event includes the steps of: connecting an Android device to an electrical device which can execute Android debug Bridge (ADB) through a USB cable to run a software program with shell permission of the Android device; establishing a cable communication way between the electrical device and the Android device with the shell permission, wherein the software program is configured to use the shell permission to inject the human input event into the Android device; changing the cable communication way into a wireless communication way with the shell permission; disconnecting the Android device from the electrical device while remaining the wireless communication way with the shell permission; and transmitting the human input event from an external device to the Android device through the wireless communication way with the shell permission.

### BACKGROUND

1. Field of Invention

The present invention relates to a method and a device. More particularly, the present invention relates to a method for transmitting a human input event and an Android device.

2. Description of Related Art

Mobile phones were demonstrated by John F. Mitchell and Dr Martin Cooper of Motorola in the 1970s. Subsequently, the first commercially available mobile phone is presented in the 1980s. From 1990 to 2011, worldwide mobile phone subscriptions grew from 12 million to over 6 billion, penetrating about 90% of the global population and reaching the bottom of the economic pyramid.

Mobile phones are used for a variety of purposes, including keeping in touch with people and conducting business. With the progression of technology, smartphones arise. Smartphones are mobile phones with more advanced computing capability and connectivity than normal mobile phones. Nowadays, smartphone has become one of the most important electrical devices in the world. People use smartphones to surf the internet, connect with friends via instant messaging software, play games, and etc.

One way to apply smartphones is using an external device, for example, a mouse or a keyboard, as a human interface device (HID) to transmit a human input event to smartphones in a wireless way, such that smartphones can execute related operations according to the human input event. However, if there is a need to transmit the human input event to smartphones in a wireless way, the smartphones need to be root thereby placing the smartphones in condition of losing warranty.

In view of the foregoing, problems and disadvantages are present in the existing smartphones that await further improvement. However, those skilled in the art have been unable to find a solution.

### SUMMARY

The following summary presents a simplified summary of the disclosure in order to provide a basic understanding to the reader. This summary is not an extensive overview of the disclosure and it does not identify key/critical elements of the present invention or delineate the scope of the present invention.

One aspect of the present disclosure is directed to a method for transmitting a human input event. The method for transmitting a human input event includes the steps of:

connecting an Android device to an electrical device which can execute Android debug Bridge (ADB) through USB cable to run a software program with shell permission of the Android device;

establishing a cable communication way between the electrical device and the Android device with the shell permission, wherein the software program is configured to use the shell permission to inject the human input event into the Android device;

changing the cable communication way into a wireless communication way with the shell permission;

disconnecting the Android device from the electrical device while remaining the wireless communication way with the shell permission; and

transmitting the human input event from an external device to the Android device through the wireless communication way with the shell permission.

Another aspect of the present disclosure is directed to an electrical device. The electrical device which can execute Android debug Bridge (ADB) is configured to be connecting to an Android device through USB cable to run a software program with shell permission on the Android device, and a cable communication way between the electrical device and the Android device with the shell permission is established. The software program is configured to use the shell permission to inject the human input event into the Android device. The cable communication way is changed into a wireless communication way with the shell permission, and the Android device is disconnected from the electrical device while remaining the wireless communication way with the shell permission. The human input event is transmitted from an external device to the Android device through the wireless communication way with the shell permission.

In view of the foregoing, embodiments of the present disclosure provide a method for transmitting a human input event and an electrical device, which can transmit a human input event from an external device to an Android device through a wireless communication way with shell permission, but there is no need to root the Android device. Therefore, the Android device would not be placed in condition of losing warranty.

These and other features, aspects, and advantages of the present invention, as well as the technical means and embodiments employed by the present invention, will become better understood with reference to the following description in connection with the accompanying drawings and appended claims.

### BRIEF DESCRIPTION OF THE DRAWINGS

The invention can be more fully understood by reading the following detailed description of the embodiment, with reference made to the accompanying drawings as follows:

FIG. 1 is a flow diagram illustrating the process steps of a method for transmitting a human input event according to embodiments of the present disclosure.

FIG. 2 is a schematic diagram of operations of an electrical device according to embodiments of the present invention.

FIG. 3 is a schematic diagram of operations of an electrical device according to embodiments of the present invention.

FIG. 4 is a schematic diagram of operations of an electrical device according to embodiments of the present invention.

FIG. 5 is a schematic diagram of operations of an electrical device according to embodiments of the present invention.

FIG. 6 is a schematic diagram of operations of an electrical device according to embodiments of the present invention.

FIG. 7 is a schematic diagram of operations of an electrical device according to embodiments of the present invention.

In accordance with common practice, the various described features/elements are not drawn to scale but instead are drawn to best illustrate specific features/elements relevant to the present invention. Also, wherever possible, like or the same reference numerals are used in the drawings and the description to refer to the same or like parts.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include the singular.

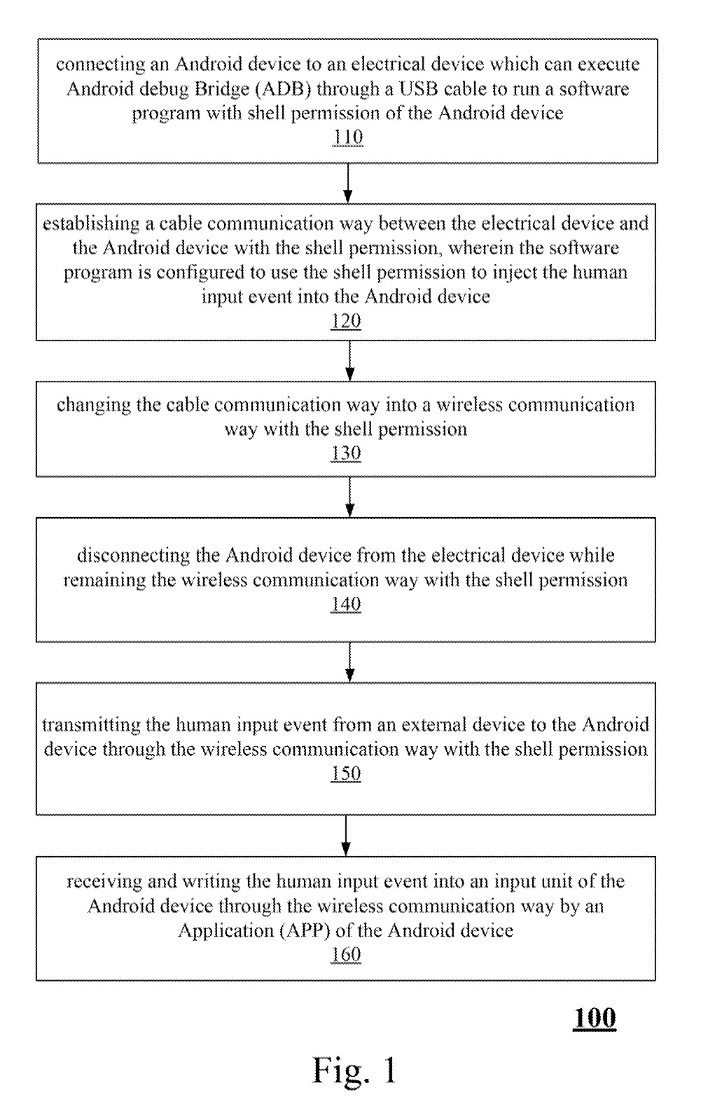

For solving the problems in the prior art, the present invention provides a method 100 as shown in FIG. 1, which is a schematic flow diagram of the method 100 for transmitting a human input event according to embodiments of the present invention. As shown in FIG. 1, the method 100 for transmitting a human input event includes the steps of:

Step 110: connecting an Android device to an electrical device which can execute Android debug Bridge (ADB) through USB cable to run a software program with shell permission of the Android device;

Step 120: establishing a cable communication way between the electrical device and the Android device with the shell permission, wherein the software program is configured to use the shell permission to inject the human input event into the Android device;

Step 130: changing the cable communication way into a wireless communication way with the shell permission;

Step 140: disconnecting the Android device from the electrical device while remaining the wireless communication way with the shell permission;

Step 150: transmitting the human input event from an external device to the Android device through the wireless communication way with the shell permission; and

Step 160: receiving and writing the human input event into an input unit of the Android device through the wireless communication way by an Application (APP) of the Android device.

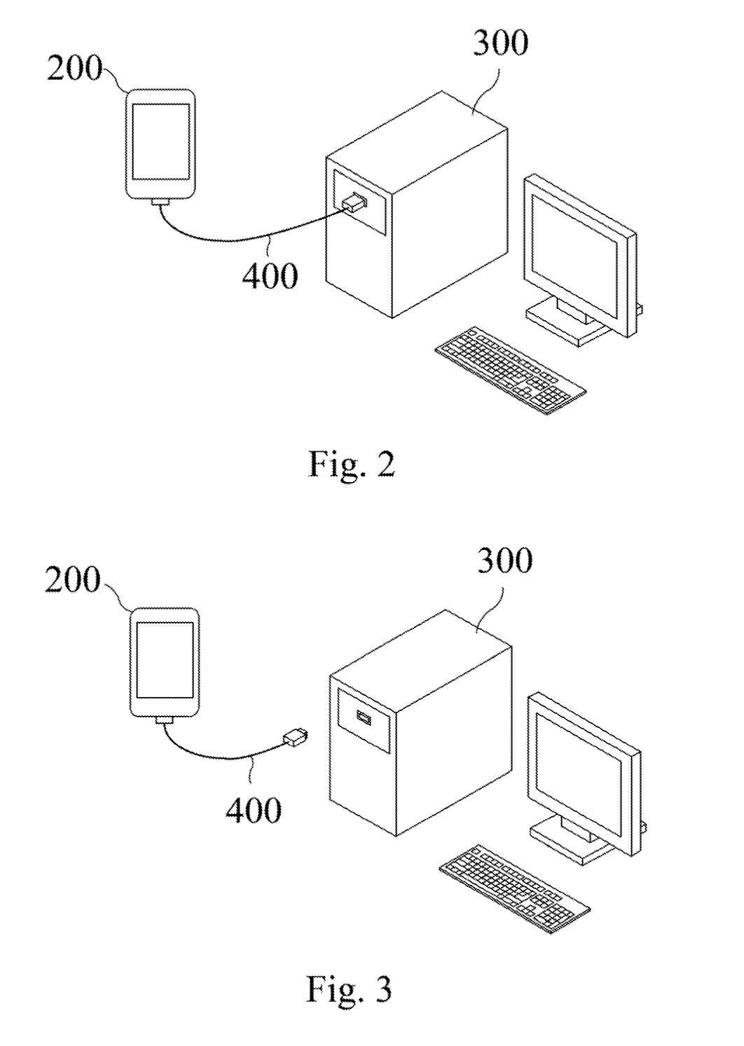

To facilitate understanding of the foregoing method 100, reference is now made to both FIGS. 1˜4, wherein FIGS. 2˜4 are schematic diagrams of operations of an electrical device 300 according to embodiments of the present invention.

In step 110, referring to both FIGS. 1 and 2, the Android device 200 is configured to be connected to an electrical device 300 which can execute Android debug Bridge (ADB) through USB cable 400 to run a software program with shell permission of the Android device 200. In the embodiment, the Android device 200 can be but not limited to a mobile phone, a tablet, or a television which employ Android, and the electrical device 300 can be but not limited to a computer.

In step 120, with respect to both FIGS. 1 and 2, a cable communication way between the electrical device 300 and the Android device 200 is established with the shell permission. In the embodiment, the software program is configured to use the shell permission to inject the human input event (e.g. Keyboard/Mouse/Touch panel) into the Android device 200.

In step 130, referring to both FIGS. 1 and 2, the cable communication way between the Android device 200 and the electrical device 300 can be changed into a wireless communication way with the shell permission. In the embodiment, the present invention further provides a program, and this program is configured to perform the foregoing changing process. Moreover, the program can further perform the changing process automatically, such that the method 100 for transmitting a human input event and the electrical device 300 can be user friendly.

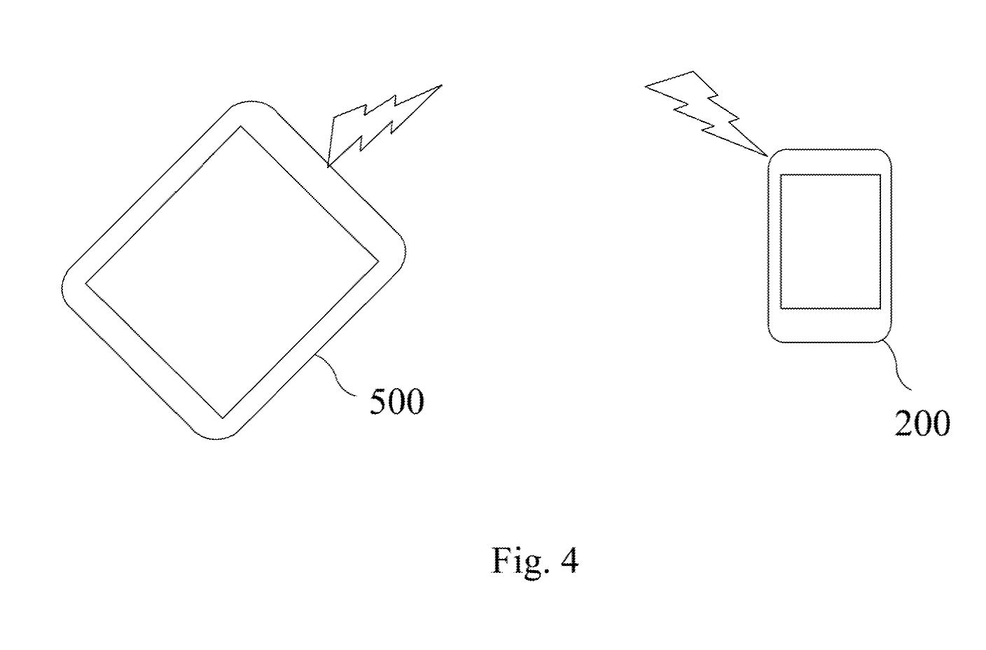

In step 140, with respect to both FIGS. 1 and 3, the Android device 200 is disconnected from the electrical device 300 while remaining the wireless communication way with the shell permission. In the embodiment, the wireless communication way can be but not limited to WiFi.

In step 150, referring to both FIGS. 1 and 4, the human input event can be transmitted from an external device 500 to the Android device 200 through the wireless communication way with the shell permission. In the embodiment, the external device 500 can be but not limited to a touch panel or a motion detection device.

As such, a method for transmitting a human input event and an Android device of embodiments of the present disclosure provide can transmit a human input event from an external device to an Android device through a wireless communication way with shell permission, but there is no need to root the Android device. Therefore, the Android device would not be placed in condition of losing warranty.

In step 160, with respect to both FIGS. 1 and 4, an Application (APP) of the Android device 200 is configured to receive and write the human input event into an input unit of the Android device 200 through the wireless communication way. In the embodiment, the present invention provides the APP. If the user installs such APP in the Android device 200 or the APP is pre-installed into the Android device 200, the APP is capable of receiving and writing the human input event into the input unit of the Android device 200 automatically, such that the method 100 for transmitting a human input event and the electrical device 300 can be user friendly.

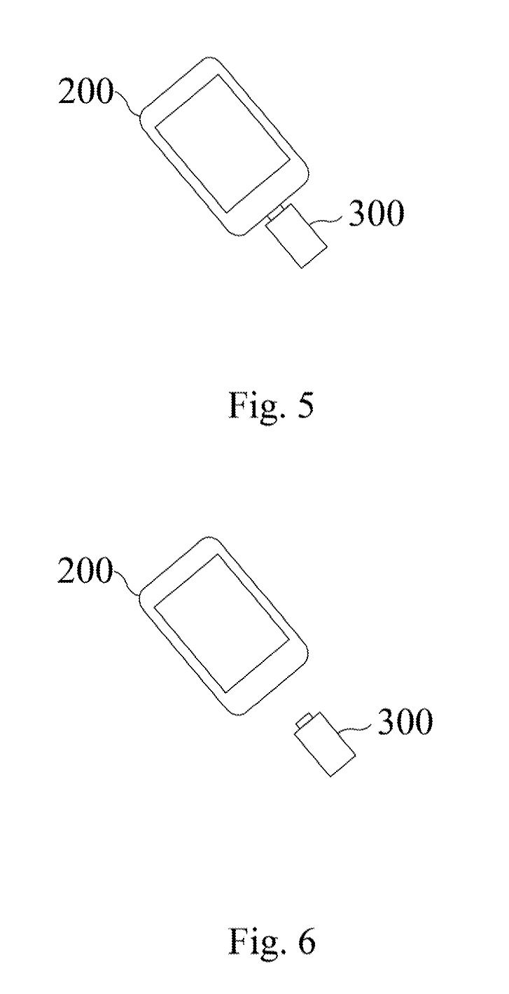

FIG. 5 is a schematic diagram of operations of an electrical device according to embodiments of the present invention. With respect to steps 110 and 120, please refer to both FIGS. 1 and 5. Compared with FIG. 2, the electrical device 300 in FIG. 5 can be but not limited to a dongle 300. As can be seen in FIG. 5, the dongle 300 can be connected to the Android device 200 through a USB port to run ADB and to run a software program of the Android device 200. Subsequently, in step 130, the ADB can be changed to run in a wireless way.

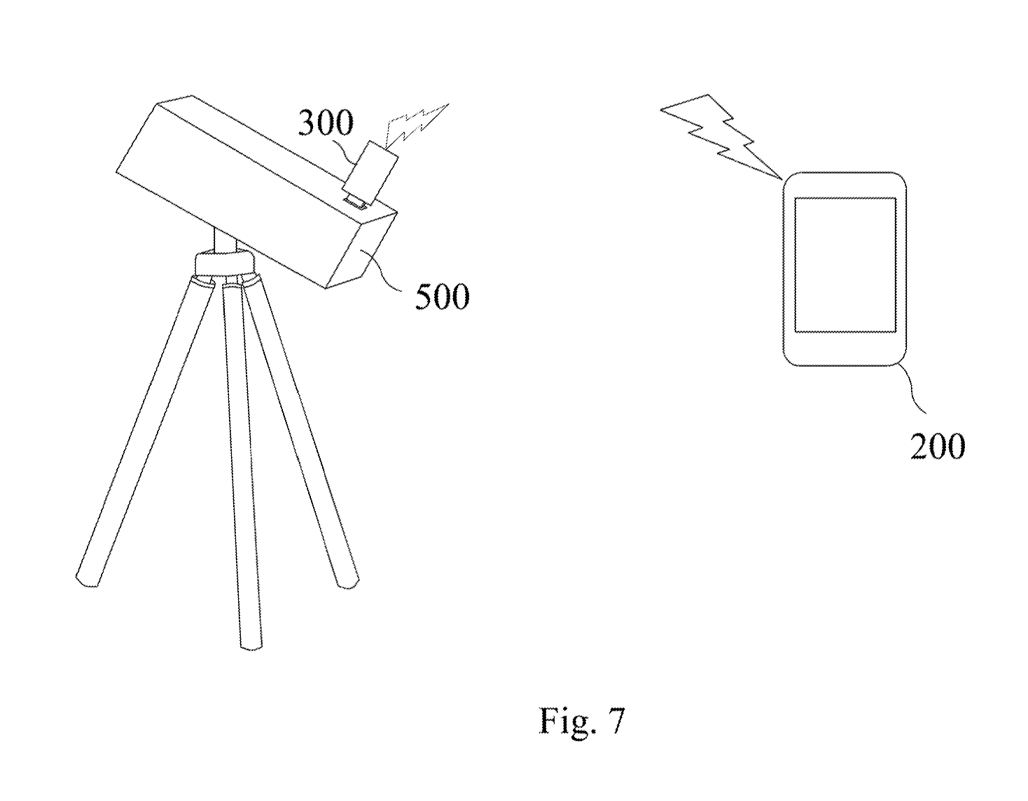

FIGS. 6 and 7 are schematic diagrams of operations of an electrical device according to embodiments of the present invention. With respect to steps 140, please refer to both FIGS. 1 and 6. The dongle 300 is disconnected from the Android device 200 while the ADB remains running in a wireless way. In step 150, please refer to both FIGS. 1 and 7. Compared with FIG. 4, the external device 500 herein can be but not limited to a motion detection device 500. With respect to FIG. 7, the dongle 300 can be electrically connected to the motion detection device 500. The human input event can be transmitted from the motion detection device 500 through the dongle 300 to the Android device 200. It should be noted that the present invention is not limited to FIGS. 5˜7. FIGS. 5˜7 are only one embodiment for exemplifying operations of the electrical device 300 according to the present invention.

In one embodiment, the method 100 for transmitting a human input event further includes the step of simulating a human interface device to control the Android device based on the human input event. As can be seen in FIG. 4, if the input unit of Android device 200 receives the human input event through the APP, every software executed in the Android device 200 can receive the human input event as well, such that the human interface device of the Android device 200 is simulated based on the human input event for controlling the Android device 200.

For example, if the external device 500 is a motion detection device, the motion detection device may detect motions of a user to generate the human input event. The human input event can be transmitted to the Android device 200 by the motion detection device through WiFi. The APP is capable of receiving and writing the human input event into the input unit of the Android device 200 automatically, and such human input event is deemed to be a real input signal of the Android device 200; therefore, the Android device 200 may execute a corresponding operation based on the human input event generated by the motion detection device. For example, if the motion of the user is double clicking an icon or a button, the motion detection device will generate the human input event based on the motion and transmit the human input event to the Android device 200. Subsequently, the Android device 200 may execute an APP or open a camera based on the foregoing motion. Furthermore, if the motion of the user is sliding page, the motion detection device will generate the human input event based on the motion and transmit the human input event to the Android device 200. Subsequently, the page on the screen image of the Android device 200 will be turned to next page. In other words, the motion detection device is simulated to be a real input device of the Android device 200.

In another embodiment, the present invention further provides a receiver. The receiver can be electrically connected to a projector for transmitting image data to the projector. For example, the Android device 200 may transmit image data corresponding to its own screen image to the receiver through WiFi, the receiver is capable of receiving and transmitting image data to the projector, and the projector can project the screen image of the Android device 200 to a projected wall. Subsequently, since above-mentioned motion detection device may be simulated to be an input device of the Android device 200, the user can use the motion detection device as an input device of the Android device 200 to present in front of the screen. Specifically, every motion of the user can be detected by the motion detection device as an input signal, the Android device 200 is configured to receive and process the input signal to execute a corresponding operation, and the screen of the Android device 200 can be projected to the projected wall via the receiver. In short, every motion of the user can activate a corresponding operation, such operation may change the screen of the Android device 200, and the changed screen will be presented in the screen.

In still another embodiment, users can be in a tent to view the screen where the projector projects images, and one of the users may tie a rope on the Android device 200 and drop it from a tree where the tent is located. Through above-mention operations, the camera of the Android device 200 may capture the image outside of the tent (e.g. the image of baby birds being fed), and the image computed by the Android device 200 can be projected to the screen via the receiver. Therefore, all users in the tent may view the image outside of the tent (e.g. the image of baby birds being fed), and meanwhile, any of the users still can annotate the image (e.g. make a mark) by the cooperation of the motion detection device, the Android device 200, the receiver, and the projector.

In another embodiment, due to the property of the projector, the projector may project images on a non-planar surface, such as an animal model. Meanwhile, a user still can annotate the image (e.g. make a mark) by the cooperation above. In still another embodiment, the projector may project images on glass. With the cooperation above, every motion of the user can activate a related operation, and such operation will be presented in the glass, and therefore, a user may present in front of the glass.

In yet another embodiment, the motion detection device may detect multi-motions. For example, we may put lots of dolls in front of a screen. With the use of the cooperation above, a user may play an interaction game by moving the dolls. Specifically the motion detection device may detect multi-motions of the user by moving the dolls and generate related input signals, the Android device 200 is configured to receive and process the input signals to execute related operations, and the frame of the Android device 200 can be projected to the screen via the receiver. In addition, features of the dolls can be remembered by the Android device 200, such that no matter where the dolls are moved to, each of the dolls can be identified by the Android device 200.

The above-described method 100 for transmitting a human input event can be implemented by software, hardware and/or firmware. For example, if an implementer determines that speed and accuracy are paramount, the implementer may opt for a mainly hardware and/or firmware implementation; if flexibility is paramount, the implementer may opt for a mainly software implementation; alternatively, the collaboration of software, hardware and firmware may be adopted. It should be noted that none of the above-mentioned examples is inherently superior to the other and shall be considered limiting to the scope of the in present invention; rather, these examples can be utilized depending upon the context in which the unit/component will be deployed and the specific concerns of the implementer.

Further, as may be appreciated by persons having ordinary skill in the art, the steps of the method 100 for transmitting a human input event are named according to the function they perform, and such naming is provided to facilitate the understanding of the present disclosure but not to limit the steps. Combining the step into a single step or dividing any one of the steps into multiple steps, or switching any step so as to be a part of another step falls within the scope of the embodiments of the present disclosure.

In view of the above embodiments of the present disclosure, it is apparent that the application of the present invention has the advantages as follows. In view of the foregoing, embodiments of the present disclosure provide a method for transmitting a human input event and an electrical device, which can transmit a human input event from an external device to an Android device through a wireless communication way with shell permission, but there is no need to root the Android device. Therefore, the Android device would not be placed in condition of losing warranty.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for transmitting a human input event, comprising:
connecting an Android device to an electrical device which can execute Android debug Bridge (ADB) through a USB cable to run a software program with shell permission of the Android device;
establishing a cable communication way between the electrical device and the Android device with the shell permission, wherein the software program is configured to use the shell permission to inject the human input event into the Android device;
changing the cable communication way into a wireless communication way with the shell permission;
disconnecting the Android device from the electrical device while remaining the wireless communication way with the shell permission; and
transmitting the human input event from an external device to the Android device through the wireless communication way with the shell permission.

2. The method of claim 1, further comprising:
receiving and writing the human input event into an input unit of the Android device through the wireless communication way by an Application (APP) of the Android device.

3. The method of claim 1, further comprising:
simulating a human interface device to control the Android device based on the human input event.

4. The method of claim 1, further comprising:
transmitting image date corresponding to a screen image of the Android device to a receiver through the wireless communication way with the shell permission;
receiving and transmitting image data to a projector by the receiver; and
projecting the screen image of the Android device to a projected wall by the projector.

5. The method of claim 1, wherein the Android device comprises one of a mobile phone, a tablet, and a television.

6. The method of claim 1, wherein the external device comprises at least one of a touch panel and a motion detection device.

7. The method of claim 1, wherein the wireless communication way comprises WiFi.

8. An electrical device, wherein the electrical device which can execute Android debug Bridge (ADB) is configured to be connecting to an Android device through a USB cable to run a software program with shell permission of the Android device, and a cable communication way between the electrical device and the Android device with the shell permission is established, wherein the software program is configured to use the shell permission to inject the human input event into the Android device; wherein the cable communication way is changed into a wireless communication way with the shell permission, and the Android device is disconnected from the electrical device while remaining the wireless communication way with the shell permission; wherein the human input event is transmitted from an external device to the Android device through the wireless communication way with the shell permission.

9. The electrical device of claim 8, further comprising:
an Application (APP) being configured to receive and write the human input event into an input unit of the Android device through the wireless communication way.

10. The electrical device of claim 8, wherein a human interface device is simulated based on the human input event to control the Android device.

11. The electrical device of claim 8, wherein the Android device comprises one of a mobile phone, a tablet, and a television.

12. The electrical device of claim 8, wherein the external device comprises at least one of a touch panel and a motion detection device.

13. The electrical device of claim 8, wherein the wireless communication way comprises WiFi.
